(19) United States
(12) Patent Application Publication
(10) Pub. No.: US 2003/0085780 A1
(43) Pub. Date: May 8, 2003

(54) Asymmetric high frequency filtering apparatus

(76) Inventor: Chin-Li Wang, Hsinchu (TW)

Correspondence Address: FISH & RICHARDSON PC, 225 FRANKLIN ST, BOSTON, MA, 02110, US

(21) Appl. No.: 10/121,629

(22) Filed: Apr. 12, 2002

(30) Foreign Application Priority Data
Nov. 7, 2001 (TW) 90127691

(51) Int. Cl. H01P 1/20

(52) U.S. Cl. 333/204

(57) ABSTRACT

An asymmetric high frequency filtering apparatus. The filter structure is made up by the multilayer to reduce high frequency band-pass filter size. By taking advantage of the cross-couple effect, the filtering apparatus has an attenuation pole above the passband or the below the passband for the asymmetric frequency response. The specification for the frequency position of attenuation pole is achieved by tuning the coupled capacitance.

This application claims priority from Taiwanese application no. 90127691, filed with the Taiwanese Patent Office, Taiwan, on Nov. 7, 2001, pursuant to 35 U.S.C. 119(a)-(d).

### BACKGROUND OF THE INVENTION

1. Field of the Invention

The invention relates to a filtering apparatus. In particular, the invention relates to an asymmetric high frequency filtering apparatus set up by semi-lump LC resonator for reducing the size of filter structure and achieving required decay of the system specification.

2. Description of the Related Art

Filters are widely employed in wireless communication. A filter is usually used to modify the waveform, restrain the transmission of resonance waves and reduce system mirror noise. Recently, there is a serious demand for filters with small volume and high quality. To make mobile wireless communication devices smaller and lighter, development of a filter with high frequency selectivity and small profile has been an important direction of modern research.

A high frequency filter structure has been mentioned in U.S. Pat. No. 6,069,542 filed on May 30, 2000.

FIG. 1 is an equivalent circuit diagram of a traditional 3-stage comb-line high-frequency filter made by the edge-coupled effect. In FIG. 1, the filter mainly includes an input coupling capacitor (Cin) connected to an input port, an output coupling capacitor (Cout) connected to an output port, three edge-coupled transmission lines (L1, L2, L3), and three capacitors (C1, C2, C3) connected separately to ground and the transmission lines (L1, L2, L3). In addition, the input coupling capacitor (Cin) is tapped to the transmission line (L1); the output coupling capacitor (Cout) is tapped to the transmission line (L3).

FIG. 2 is a frequency response of the equivalent circuit in FIG. 1. In FIG. 2, there is no attenuation pole approaching the band-pass of the frequency response. Therefore, if any unwanted signal approaches the passband, this kind of filter structure is unable to provide enough decay to filter out the unwanted signal.

FIG. 3a is another equivalent circuit diagram of a traditional 3-stage comb-line high frequency filter with an attenuation pole below the passband. The filter in FIG. 3a has a similar structure to the filter in FIG. 1. The first stage resonator, made up by a first capacitor (C11) and a first transmission line (SL11), and the third stage resonator, made up by a third capacitor (C13) and a third transmission line (SL13), are not directly connected to ground. These two resonators are both connected to a transmission line (Lg) and the other node of the transmission line (Lg) is connected to ground. FIG. 3b is a frequency response of the equivalent circuit in FIG. 3a. In FIG. 3b, there is an attenuation pole below the passband when tuning the inductance (Lg) within 0.1 nH to 0.2 nH. Referring to the equivalent circuit in FIG. 4a, if the positions of the output capacitor (Cout) and the inductance (Lg), which are separately connected to two sides of the third stage resonator in FIG. 3a, are exchanged, there will be an attenuation pole above the passband as shown in FIG. 4b.

FIG. 5 is a layout exploded perspective view of the equivalent circuit in FIG. 3a. In FIG. 5, the substrate (11) is made up by laminating six dielectric layers, or the 1st layer (11a) to the 6th layer (11f). In practice, however, there are some disadvantages of the structure as shown in FIG. 5.

1. It is difficult to achieve a pure series capacitor in the multilayer structure. To realize a series capacitor in this structure must accompany a parasitic grounding capacitor, and this parasitic grounding capacitor limits the multilayer structure to realize the equivalent circuit.

2. In practice, the filter is exposed, or the 6th layer (11f) isn't a protection layer, to reduce the influence of the parasitic capacitor. This causes the circuit of the filter structure to be influenced by the peripheral circuit or electromagnetic wave and limit the application of the structure in an integrated module.

### SUMMARY OF THE INVENTION

An object of the present invention is to provide an asymmetric 3-stage high-frequency filtering apparatus made up by semi-lump LC resonator. The high impedance transmission lines form the main coupling and there is a weak cross-coupled capacitor added between the first and the third stage of resonators. Therefore, the required decay of system specification can be achieved without any additional filtering stage and the size of the filter structure can be reduced when applied to the multiplayer ceramic filter.

The asymmetric high-frequency filtering apparatus includes the elements of a first resonator having a first grounding capacitor connected in series with a first transmission line; a second resonator connected in parallel with the first resonator and having a second grounding capacitor connected in series with a second transmission line; a third resonator connected in parallel with the second resonator and having a third grounding capacitor connected in series with a third transmission line; and a weak-coupled capacitor coupled between the first resonator and the third resonator. As in the filtering apparatus mentioned above, the first transmission line is edge-coupled with the second transmission line; the second transmission line is edge-coupled with the third transmission line to form the main coupling of the filtering apparatus; and the weak-couple capacitor modifies the frequency position of the attenuation pole.

### BRIEF DESCRIPTION OF THE DRAWINGS

These features, aspects, and advantages of the present invention will become better understood with reference to the following description, appended claims and accompanying diagrams:

FIG. 1 (prior art) is an equivalent circuit diagram of the traditional 3-stage comb-line high frequency filter made up by the edge-coupled effect;

FIG. 2 (prior art) is a frequency response of the equivalent circuit in FIG. 1;

FIG. 3a (prior art) is another equivalent circuit diagram of the traditional 3-stage comb-line high frequency filter with an attenuation pole below the passband;

FIG. 3b (prior art) is a frequency response of the equivalent circuit in FIG. 3a;

FIG. 4a (prior art) is another equivalent circuit diagram of the traditional 3-stage comb-line high frequency filter with an attenuation pole above the passband;

FIG. 4b (prior art) is a frequency response of the equivalent circuit in FIG. 4a;

FIG. 5 (prior art) is a layout exploded perspective view of the equivalent circuit in FIG. 3a;

FIG. 6 is an equivalent circuit diagram with an attenuation pole below the passband according to the present invention;

FIG. 7 is another equivalent circuit diagram with an attenuation pole below the passband according to the present invention;

FIG. 8 is an equivalent circuit diagram with an attenuation pole above the passband according to the present invention;

FIG. 9 is a frequency response of the equivalent circuit in FIG. 6;

FIG. 10 is a frequency response of the equivalent circuit in FIG. 8;

FIG. 11 is a layout exploded perspective view of the equivalent circuit in FIG. 6; and

FIG. 12 is another layout exploded perspective view of the equivalent circuit in FIG. 6.

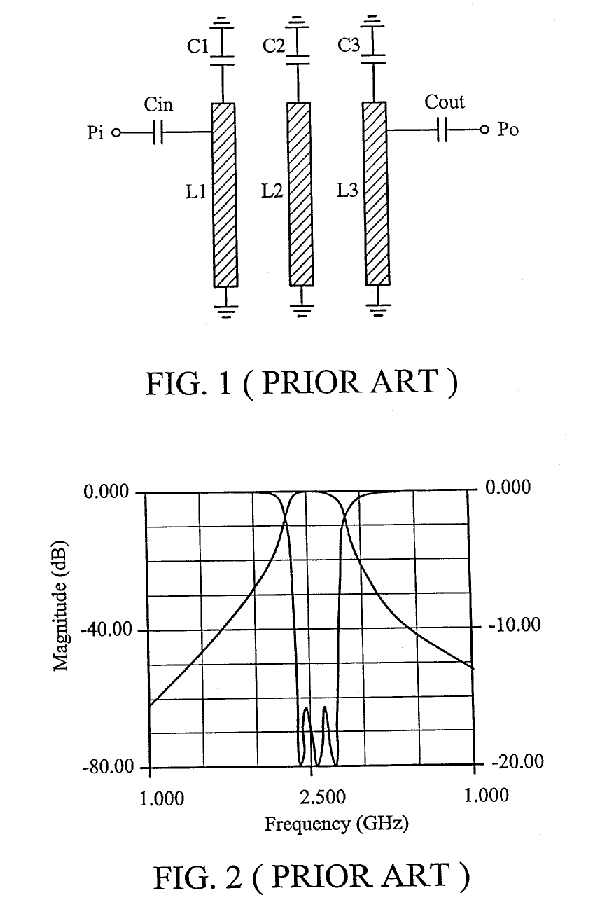

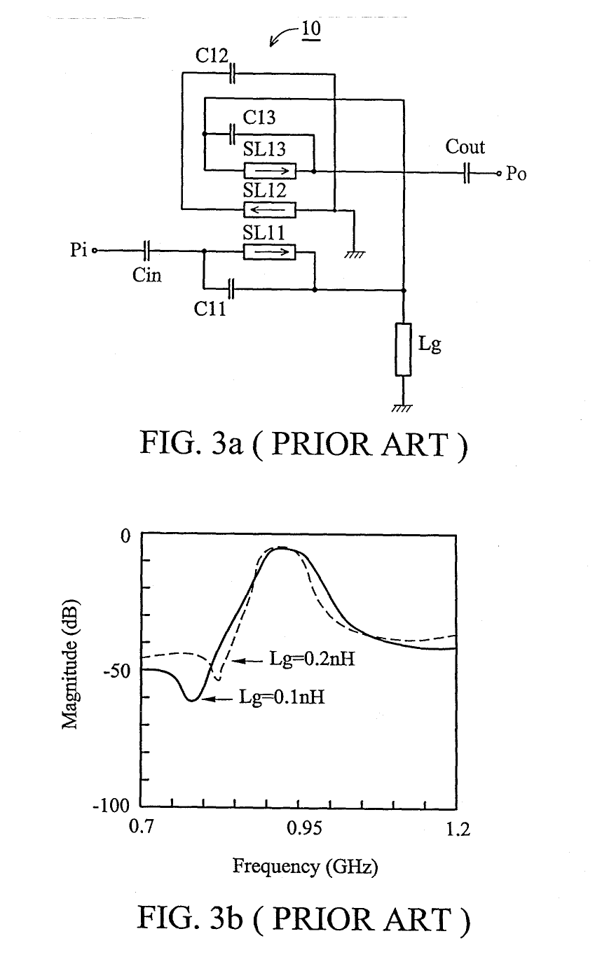

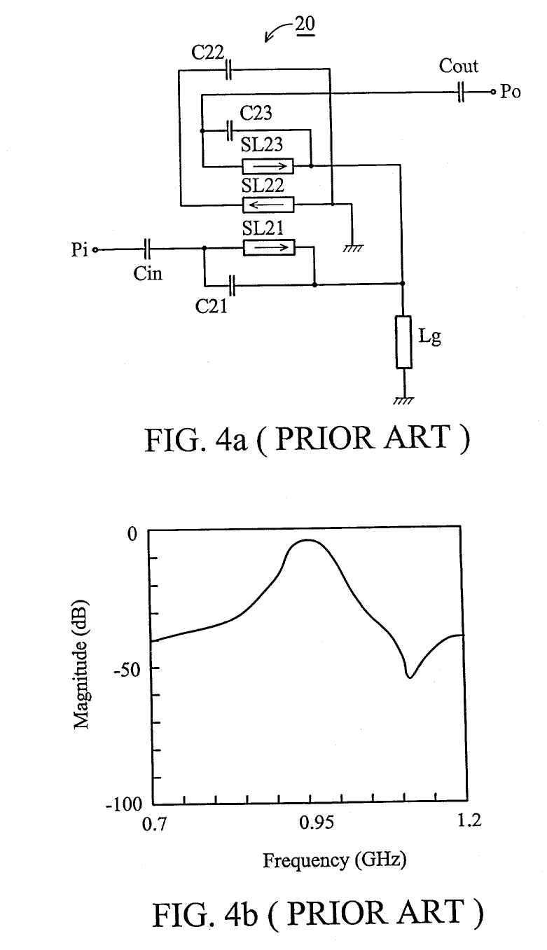

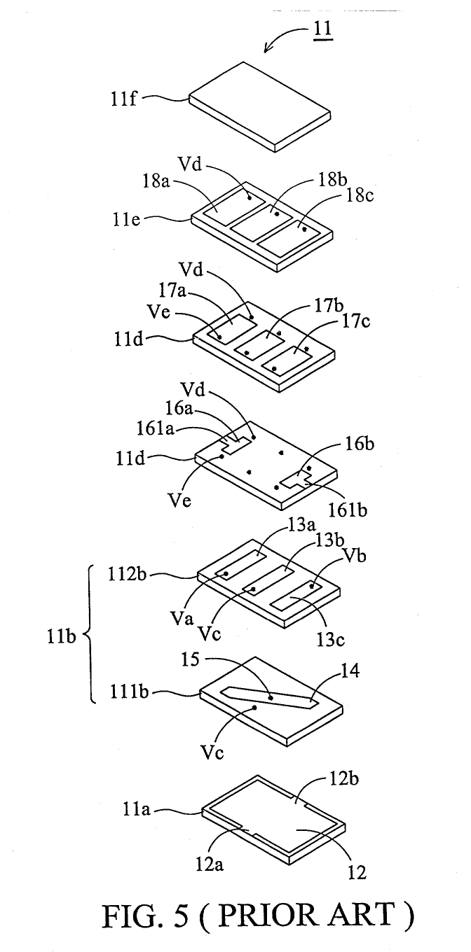

### DETAILED DESCRIPTION OF THE INVENTION

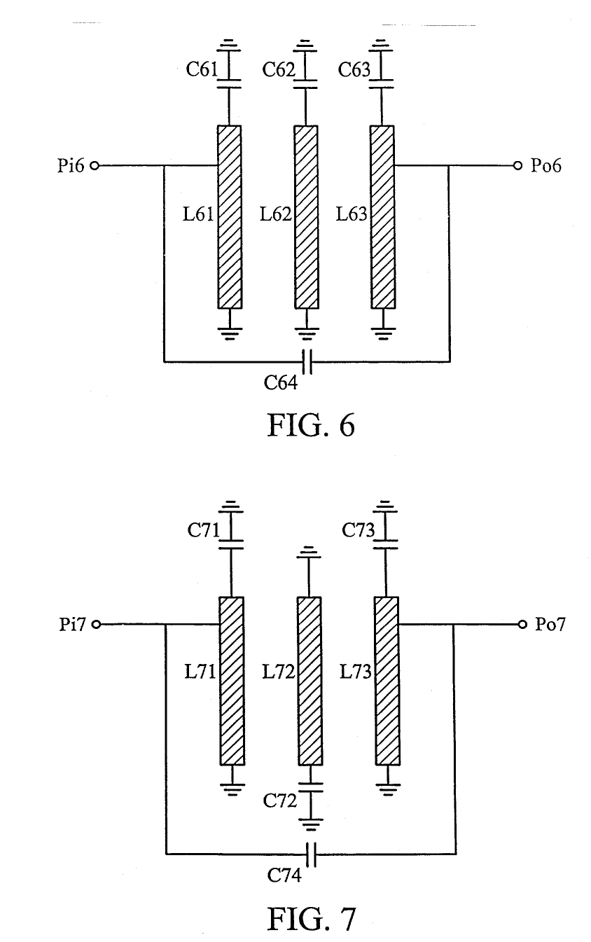

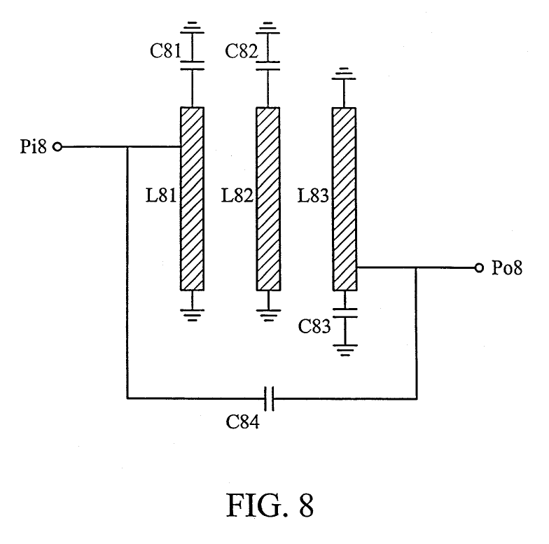

FIG. 6 and FIG. 7 are equivalent circuit diagrams with an attenuation pole below the passband according to the present invention. FIG. 8 is an equivalent circuit diagram with an attenuation pole above the passband according to the present invention. The equivalent circuit of the FIG. 6 includes a first resonator, a second resonator, a third resonator, and a weak-coupled capacitor (C64), wherein the first resonator has a first grounding capacitor (C61) connected in series with a first transmission line (L61); the second resonator has a second grounding capacitor (C62) connected in series with a second transmission line (L62); the third resonator has a third grounding capacitor (C63) connected in series with a third transmission line (L63). The weak-coupled capacitor (C64), which is used to modify the position of the attenuation pole of the frequency response, is coupled between the first resonator and the third resonator. The first transmission line (L61) is edge-coupled with the second transmission line (L62); the second transmission line (L62) is edge-coupled with the third transmission line (L63), and both form the main coupling of this filter structure. The first transmission line (L61) is tapped to an input port (Pi6), and the third transmission line (L63) is tapped to an output port (Po6). Additionally, because of the weak-couple capacitor (C64) coupled between the first resonator and third resonator, there is an attenuation pole approaching the band-pass. In practice, it is used to modify the frequency position of the attenuation pole of the frequency response by tuning the value of the weak-coupled capacitor (C64) without influencing the characteristic of the passband. As well, the input port (Pi6) and the output port (Po6) are made up by tape technique to transform the impedance and avoid the parasitic capacitance effect by reducing the layers of the multilayer structure.

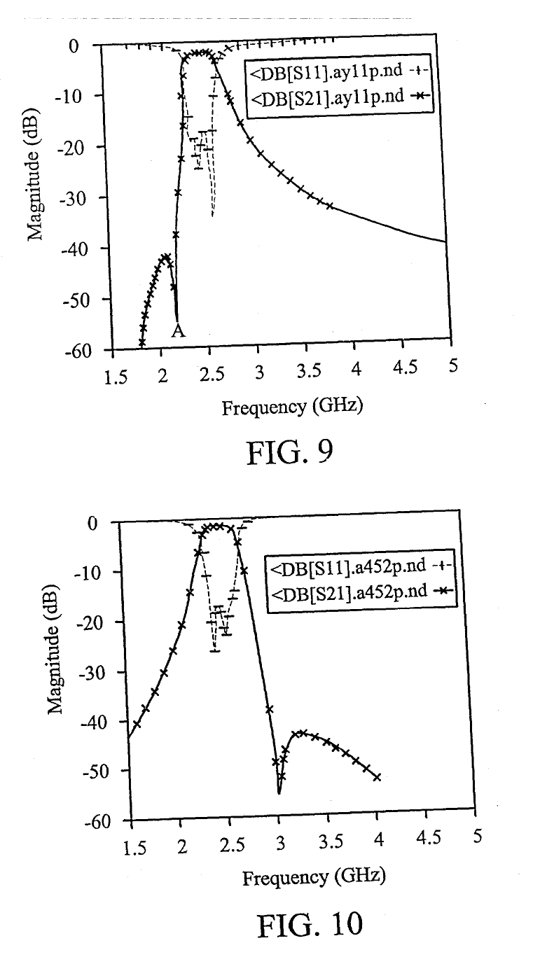

Referring to FIG. 7 and FIG. 8, the structures in FIG. 7 and FIG. 8 are similar to the structure in FIG. 6, but, as shown in FIG. 7, the grounding capacitor (C72) of the second resonator is arranged at the opposite position to the grounding capacitor (C62) in FIG. 6. In FIG. 8, the grounding capacitor (C83) of the third resonator is arranged at the opposite position to the grounding capacitor (C63) in FIG. 6 and the output port (Po8) is arranged at the lower position of the third transmission line (L83). Being analyzed the structures in FIG. 6 and in FIG. 8 separately by a 3D electromagnetic field simulation program (ex: SONNET.) generates the frequency response with an attenuation pole (about 2.2 MHz as shown in FIG. 9) below the passband, or an attenuation pole (about 3.0 MHz as shown in FIG. 10) above the passband.

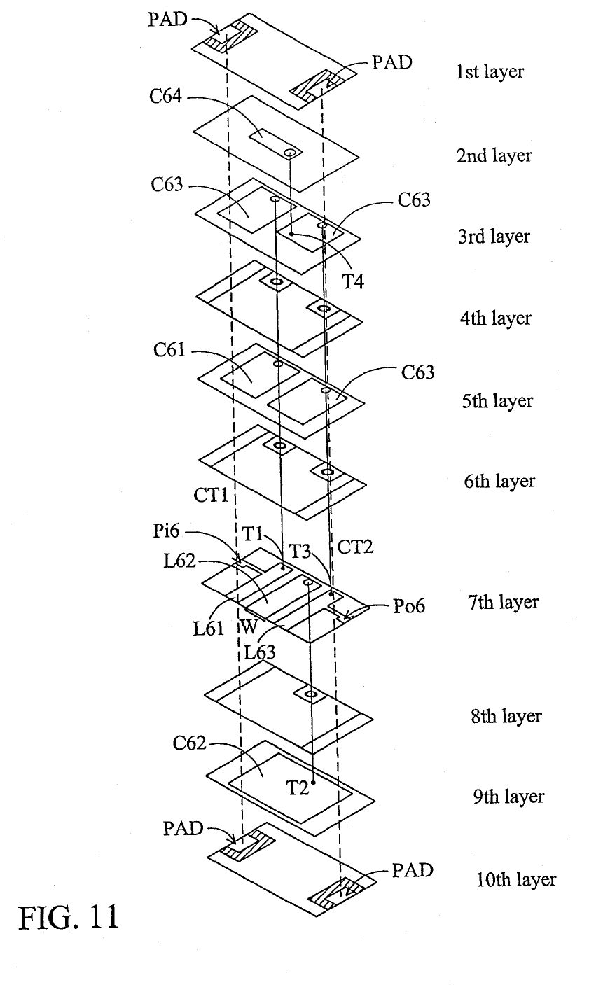

FIG. 11 is a layout exploded perspective view of an equivalent circuit in FIG. 6. FIG. 11 shows a filter structure produced by the low temperature co-fire ceramic technique. The practical size of the filter structure working at 2.4 GHz is 3.2 mm*2.5 mm*1.5 mm.

In FIG. 11, there are 9 dielectric layers in the present embodiment. The thickness of the layers from top to bottom are 3.6-3.6-3.6-3.6-3.6-3.6-10.8-14.4-3.6-3.6 (mil). The 1st and 10th metal layers are grounding layers covering the whole filter structure to separate the outside noise. The 4th, 6th, and 8th electrode layers are shielding layers, which are edge-coupled to ground. All of the electrode layers are composed of electric conductive material such as Ag or Cu. All of the grounding capacitors mentioned above in the equivalent circuit are constructed of metal-insulator-electrode layers. In FIG. 6, the capacitors (C61) and (C63) are interlaced with a electrode layer and an shielding ground layer from 3rd to 6th layers. The transmission lines (L61, L62, L63), and the capacitor (C62) are constructed of the layers from 7th to 10th. In this embodiment, the weak-coupled capacitor (C64) is arranged on the 2nd layer and electrically conducted to a point (T) on the 3rd layer by a predetermined hole to form cross-coupling between the grounding capacitors (C61) and (C63). The second resonator shown in FIG. 6 is constructed by the transmission line (L62) on the 7th layer conducted to the grounding capacitor (C62) on the 9th layer by a predetermined hole through the 8th layer. Similarly, the first resonator is constructed by the transmission line (L61) on the 7th layer conducted to the grounding capacitor (C61) on the 3rd layer by a left hole through the 4th, 5th, and 6th layers; the third resonator is constructed by the transmission line (L63) on the 7th layer conducted to the grounding capacitor (C63) on the 3rd layer by a right hole through the 4th, 5th, and 6th layers.

Considering the same area of capacitors, the capacitance is proportional to the number of layers. In practice, therefore, the number of layers isn't limited to the number shown in this embodiment. High capacitance can be achieved by increasing the number of layers. The area of transmission lines (L61, L62, L63) can be adjusted according to practical requirements and is not limited to the case in this embodiment. The input port (Pi6) conducted to the transmission line (L61) and the output port (Po6) conducted to the transmission line (L63) on 7th layer are constructed of tape technique and connected to the pads (PAD) on the 1st and 10th layers separately, as the dotted lines (CT1, CT2) show in FIG. 11. The portion near the pads (PAD) is electrically insulated to avoid influencing the input/output signal.

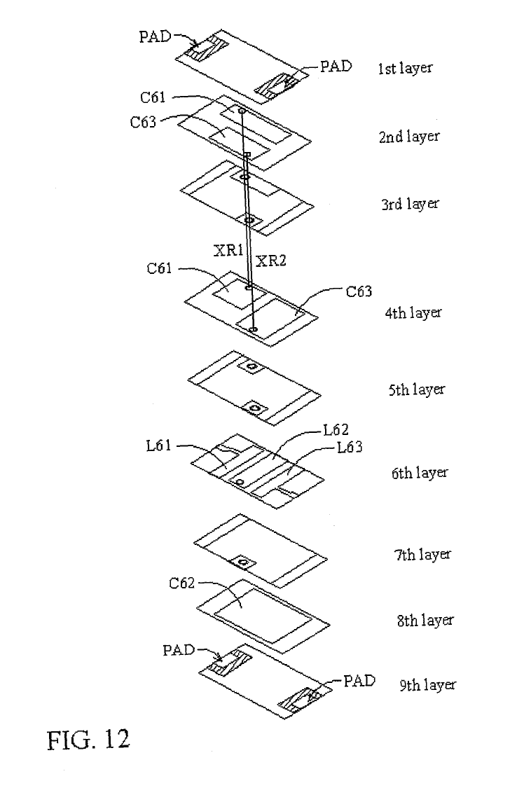

FIG. 12 is another layout exploded perspective view of the equivalent circuit in FIG. 6. Comparing FIG. 11 with FIG. 12, the layout of the weak-coupled capacitor (C64) is different. The hole on 2nd layer is connected to the hole on 4th layer through the hole on 3rd layer, as the lines (XR1, XR2) shown in FIG. 12. Therefore, there is a cross-effective region (not shown) produced by the transverse arranged metal layer (C61a) and (C63a) on 2nd layer and the vertical arranged metal layer (C61b) and (C63b) on 4th layer. The cross-effective region is used as a weak-coupled capacitor (C64) mentioned in FIG. 6 and is able to achieve the same goal of the weak-coupled capacitor (C64) in FIG. 11.

It is to be understood that the present invention is not limited to the embodiments described above, but encompasses any and all embodiments within the scope of the following claims.

What is claimed is:

1. An asymmetric high frequency filtering apparatus, comprising:
a first resonance unit, having a first grounding capacitance device connected in series with a first transmission line device;
a second resonance unit, connected in parallel with the first resonance unit and having a second grounding capacitance device connected in series with a second transmission line device;
a third resonance unit, connected in parallel with the second resonance unit and having a third grounding capacitance device connected in series with a third transmission line device; and
a weak-coupled capacitance device, coupled between the first resonance unit and the third resonance unit to modify the frequency position of the attenuation pole.

2. The filtering apparatus as claimed in claim 1, wherein the first transmission line device is edge-coupled with the second transmission line device, and the second transmission line device is edge-coupled with the third transmission line device to form the main coupling of the filtering apparatus.

3. The filtering apparatus as claimed in claim 1, wherein the first transmission line device is connected to an input port, and the third transmission line device is connected to an output port.

4. The filtering apparatus as claimed in claim 3, wherein the input port and the output port are made up by tape technique.

5. The filtering apparatus as claimed in claim 1, wherein the first transmission line device is connected to an output port, and the third transmission line device is connected to an input port.

6. The filtering apparatus as claimed in claim 5, wherein the input port and the output port are made up by tape technique.

7. The filtering apparatus as claimed in claim 1, wherein the first transmission line device, the second transmission line device and the third transmission line device are in the same plane.

8. An asymmetric high frequency filtering apparatus, comprising:
a first capacitance assembly, having a first electrode layer placed under a first grounding layer, wherein the first grounding layer covers the outside surface of the filtering apparatus to separate the outside noise, and the first electrode layer has a layout for forming weak coupled capacitance devices;
a second capacitance assembly, having a second electrode wiring layer placed over at least a first shielding layer and edge-coupled with the first capacitance assembly, and the second electrode layer, electrically conducted to the first electrode layer by predetermined holes, has a layout for forming two capacitance devices;
a transmission line assembly, having a third electrode layer placed over a second shielding layer, and the third electrode layer, electrically conducted to the second electrode layer by predetermined holes, has a layout for forming three transmission line devices; and
a third capacitance assembly, having a fourth wiring layer placed over a second grounding layer and edge-coupled with the transmission line assembly, wherein the second grounding layer covers the other surface of the filtering apparatus to separate the outside noise, and the fourth electrode layer, electrically conducted to the third electrode layer by predetermined holes, has a layout for forming capacitance devices.

9. The filtering apparatus as claimed in claim 8, wherein all three of the transmission line devices are in the same plane.

10. The filtering apparatus as claimed in claim 8, wherein the transmission line devices comprise a first transmission line device with an input port, a third transmission line device with an output port and a second transmission line device.

11. The filtering apparatus as claimed in claim 10, wherein the input port and the output port are made up by tape technique.

12. The filtering apparatus as claimed in claim 10, wherein the first transmission line device is edge-coupled with the second transmission line device, and the second transmission line device is edge-coupled with the third transmission line device to form the main coupling of the filtering apparatus.

13. An asymmetric high frequency filtering apparatus, comprising:
a first capacitance assembly, having a first electrode layer placed over a first shielding layer, and a first electrode layer has a transverse layout for forming two capacitance devices;
a second capacitance assembly, having a second electrode layer placed over a second shielding layer, and the second electrode layer, electrically conducted to the first electrode layer by predetermined holes, has a vertical layout for forming weak coupled capacitance devices;
a transmission line assembly, having a third electrode layer, wherein the third electrode layer has a layout for forming three transmission line devices and electrically conducted in parallel to the first electrode layer and the second shielding layer by predetermined holes;
a third capacitance assembly, having a fourth electrode layer placed under a third shielding layer, wherein the fourth electrode layer has a layout for forming capacitance devices; and
a separation assembly, having a first grounding layer and a second grounding layer covering the first capacitance assembly, the second capacitance assembly, the third capacitance assembly and the transmission line assembly to separate the outside noise.

14. The filtering apparatus as claimed in claim 8, wherein all three of the transmission line devices comprise a first transmission line device with an input port, a third transmission line device with an output port and a second transmission line device, the first transmission line device is edge-coupled with the second transmission line device, and the second transmission line device is edge-coupled with the third transmission line device to form the main coupling of the filtering apparatus.

15. The filtering apparatus as claimed in claim 14, wherein the input port and the output port are made up by tape technique.
